(19) United States
(12) Patent Application Publication
(10) Pub. No.: US 2010/0279257 A1
(43) Pub. Date: Nov. 4, 2010

(54) METHOD FOR FACILITATING WEIGHT LOSS

(76) Inventor: Gabrielle Annette SORENSEN, Lower Hutt (NZ)

Correspondence Address: BIO INTELLECTUAL PROPERTY SERVICES (BIO IPS) LLC, 8509 KERNON CT., LORTON, VA, 22079, US

(21) Appl. No.: 12/808,360

(22) PCT Filed: Dec. 22, 2008
(86) PCT No.: PCT/NZ2008/000343

§ 371 Date: Jun. 15, 2010

(30) Foreign Application Priority Data
Dec. 24, 2007 (NZ) 564724

(51) Int. Cl. G09B 19/00; A47G 19/02

(52) U.S. Cl. 434/127; 220/574

(57) ABSTRACT

A method for facilitating weight loss comprises consuming meals (1) for a first set period of time wherein such meals (1) occupy a first predetermined volume on or in a container A. After the first set period of time has run its course smaller meals (2) are consumed for a second set period of time wherein such meals occupy a second predetermined volume on or in a container B. The second predetermined volume is a set percentage less than the first predetermined volume. After the second set period of time has run its course, still smaller meals (3) are consumed for the third set period of time wherein such meal occupy a third predetermined volume on or in a container C wherein the third predetermined volume is a set percentage less than the second predetermined volume.

### FIELD OF INVENTION

A preferred form of this invention relates to a method for facilitating weight loss.

### BACKGROUND

It is known that obesity or being overweight is a common cause of health problems. There are numerous health benefits from maintaining a healthy weight. One way for an overweight person to reduce weight is to eat less food. Eating less food can often only be achieved when the eating habits of an overweight person are modified. It is accordingly an object of a preferred form of the invention to go at least some way towards addressing this problem or to at least provide the public with a useful choice.

The term “comprising” or derivatives thereof (eg “comprises”), if and when used herein, should be interpreted non-exclusively—eg if used in relation to a specific combination of features they should not be taken to exclude the possibility of additional unspecified features.

### SUMMARY OF THE INVENTION

According to one aspect of the invention there is provided a method for facilitating weight loss comprising the steps:
a) consuming meals for a first set period of time wherein such meals occupy a first predetermined volume on or in a container,
b) after the first set period of time has run its course, consuming meals for a second set period of time wherein such meals occupy a second predetermined volume on or in a container wherein the second predetermined volume is a set percentage less than the first predetermined volume,
c) after the second set period of time has run its course, consuming meals for a third set period of time wherein such meals occupy a third predetermined volume on or in a container wherein the third predetermined volume is a set percentage less than the second predetermined volume, and
d) optionally progressively reducing meal sizes over subsequent predetermined set periods of time in the same manner as above until a final meal size is reached.

Preferably the percentage drops at each reduction are a set percentage of the meal consumed for the immediately preceding set period of time in each case, or alternatively a set percentage of the first meal.

Preferably each container is a plate or bowl.

Optionally a set of rings is used to gauge meal size for the first, second and third set periods of time, the ring used for gauging meals for the second period of time being smaller than the ring used for gauging meals for the first period of time, the ring used for gauging meals for the third period of time being smaller than the ring used for gauging meals for the second period of time, and wherein the container for each period of time may be the same or different.

Optionally the container or ring for each of the second, third and subsequent set periods of time reduces in size by a set percentage to correspond with the lessening predetermined volume.

Preferably each of the first, second, third and subsequent set periods of time for consuming meals are for a reasonable length of time such as two weeks to one month.

Preferably the predetermined volume occupied by meals reduces by a set amount of approximately 5 percent, approximately 10 percent, approximately 15 percent, approximately 20 percent, approximately 25 percent or approximately 30 percent, in each case wherein the percentage drops are based on the meal consumed for the immediately preceding set period of time or are based on the first meal.

According to a further aspect of the invention there is provided a set of eating dishes, the set having dishes of descending sizes, the set being for use in a method for facilitating weight loss as described above.

Preferably the set comes with instructions to a user to follow a method as described above.

### DESCRIPTION OF THE DRAWINGS/IMAGES

Some preferred forms of the invention will now be described by way of example and with reference to the accompanying drawings, of which

FIG. 1 is a perspective view illustrating meals and containers in diminishing sizes; and

FIG. 2 is a perspective view illustrating a set of rings for gauging meal size in relation to a method for facilitating weight loss.

### DETAILED DESCRIPTION

According to the invention a method for facilitating weight loss involves a person consuming meals 1 contained on a plate A. The meals 1 and plate A are full sized and are consumed, for example as an evening meal, for a set period of time such as one month. The meals can of course be varied day to day but they are all full sized, occupying substantially the same volume or area on the plate A.

After the first one month period has run its course the person moves to a plate B which is smaller than the plate A. In this embodiment of the invention the smaller plate B is 85% of the size of the full sized plate A. The smaller plate B is filled with a meal 2 as shown, but because the plate B is 15% smaller the meal 2 is also 15% smaller, even though the plate B is full. The person consumes evening meals 2 using the smaller plate B for a further one month, and again the meals 2 may be varied day to day as desired. The person sees a full plate B with each meal 2 and so may not be so likely to feel that the meal size is inadequate.

After the second one month period has run its course the person moves to a third plate C which is smaller than the second mentioned plate B. In this embodiment of the invention the third plate C is 15% smaller than the second mentioned plate B. The third plate C is filled with a meal 3 as shown, but because that plate is 15% smaller than the second mentioned plate B the meal 3 is 15% smaller than the second mentioned meal 2, even though the plate C is full. The person consumes evening meals 3 using the third plate C for a further one month, and again the meals 3 may be varied day to day as desired. As before, the person sees a full plate C with each meal 3 and so may not be so likely to feel that the meal size is inadequate.

This reduction in plate and meal size can continue as described above until a desired meal size and/or body weight is achieved. The method may be applied to breakfast, lunch and evening meals, or only some of these, and may also be applied to any snacks that are habitually taken.

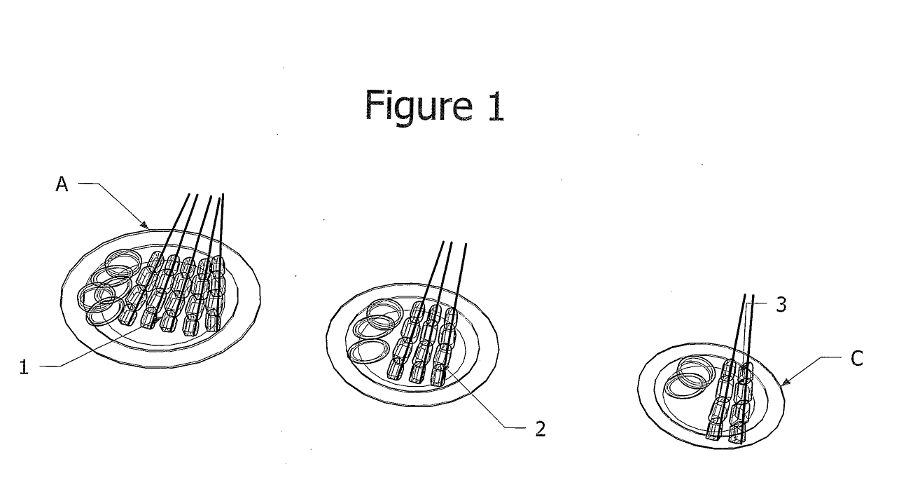

While FIG. 1 describes the invention in the context of plates of reducing size, the same principle can be applied to other forms of containers, eg bowls, etc. It is not essential to reduce meal sizes by 15% at each reduction, and in other embodiments of the invention alternative percentage reductions can be used, for example 1%, 2%, 3%, 4%, 5%, 6%, 7%, 8%, 9%, 10%, 11%, 12%, 13%, 14%, 16%, 17%, 18%, 19%, 20%, 21%, 22%, 23%, 24%, 25%, 26%, 27%, 28%, 29% or 30%. It is however desirable that the percentage reduction is constant, either calculated with the immediately previous series of meals as the reference point or the first series of meals as the reference point. It is also not necessary to stay with each meal size for one month as individuals may find other set periods that work well for them.

The container that a person starts with can be calculated on the basis of the height or starting weight of the person. For example containers may be made available in sets, each container within the set having a number or letter indicating the start size for a person based on their height or weight or sex.

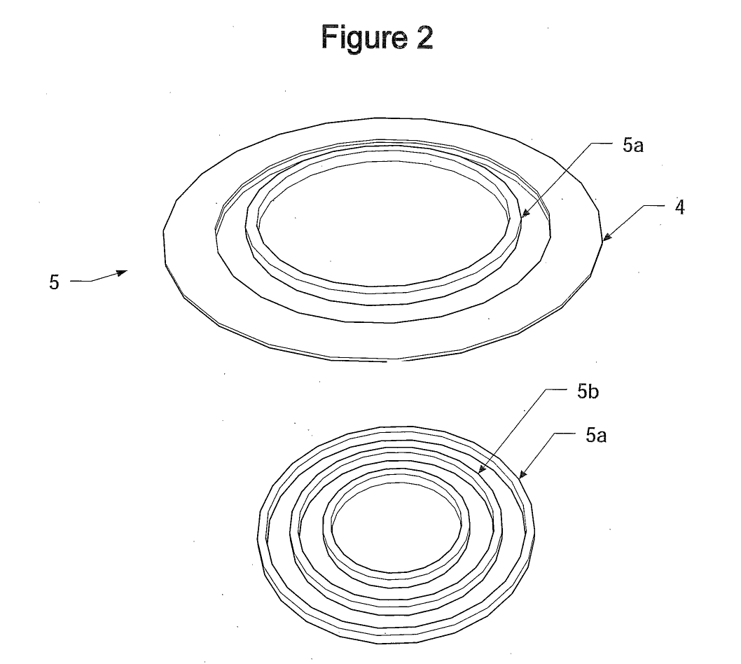

With reference to FIG. 2, in another embodiment of the invention a person seeking to reduce their food intake in stages can use a single full sized plate 4 for all of the series' of meal sizes as opposed to moving to smaller plates at each step. To facilitate this a set of measuring rings 5 is used. One of the rings 5a is placed on the plate 4 and the meal is then arranged on the plate within the ring 5a. The ring 5a can be removed when the meal is actually eaten but by then it will have served its purpose, namely enabling one to gauge meal size. When moving to the next series of smaller meals a smaller ring 5b is used and the procedure is repeated with ever smaller rings until one has arrived at the desired meal size. Each ring may be 10% smaller than the previous ring although other size progressions may be employed if preferred. For example the rings may diminish in size by 1%, 2%, 3%, 4%, 5%, 6%, 7%, 8%, 9%, 10%, 11%, 12%, 13%, 14%, 16%, 17%, 18%, 19%, 20%, 21%, 22%, 23%, 24%, 25%, 26%, 27%, 28%, 29% or 30% at each downward step.

While some preferred embodiments of the invention have been described by way of example it should be appreciated that modifications and improvements can occur without departing from the scope of the following claims.

1-13. (canceled)

14. A method for facilitating weight loss comprising the steps:
a) consuming meals for a first set period of time wherein such meals occupy a first predetermined volume on or in a container,
b) after the first set period of time has run its course, consuming meals for a second set period of time wherein such meals occupy a second predetermined volume on or in a container wherein the second predetermined volume is a set percentage less than the first predetermined volume,
c) after the second set period of time has run its course, consuming meals for a third set period of time wherein such meals occupy a third predetermined volume on or in a container wherein the third predetermined volume is a set percentage less than the second predetermined volume, and
d) optionally progressively reducing meal sizes over subsequent predetermined set periods of time in the same manner as above until a final meal size is reached.

15. A method according to claim 14, wherein the percentage drops at each reduction are a set percentage of the meal consumed for the immediately preceding set period of time in each case, or alternatively a set percentage of the first meal.

16. A method according to claim 14 or 15, wherein each container is a plate or bowl.

17. A method according to claim 14, wherein a set of rings is used to gauge meal size for the first, second and third set periods of time, a second ring used for gauging meals for the second period of time being smaller than a first ring used for gauging meals for the first period of time, a third ring used for gauging meals for the third period of time being smaller than the ring used for gauging meals for the second period of time, and wherein the container for each period of time may be the same or different.

18. A method according to claim 17, wherein the container or ring, whichever is appropriate for the claim dependency, for each of the second, third and subsequent set periods of time reduces in size by a set percentage to correspond with the lessening predetermined volume.

19. A method according to claim 14, wherein each of the first, second, third and subsequent set periods of time for consuming meals are for two weeks to one month.

20. A method according to claim 14, wherein the predetermined volume occupied by meals reduces by a set amount of approximately 5 percent, approximately 10 percent, approximately 15 percent, approximately 20 percent, approximately 25 percent or approximately 30 percent, in each case wherein the percentage drops are based on the meal consumed for the immediately preceding set period of time or are based on the first meal.

21. A set of eating dishes, the set having dishes of descending sizes, the set being for use in a method for facilitating weight loss according to claim 14, the set comprising a dish of a first predetermined size, a dish of a second predetermined size that is a set percentage smaller than the first dish, a dish of a third predetermined size that is the same set percentage less than the second dish, and optionally dishes of further predetermined sizes wherein each subsequent dish is the same set percentage smaller than the dish preceding it.

22. A set of eating dishes according to claim 21, wherein the predetermined volume occupied by meals reduces by a set amount of approximately 5 percent, approximately 10 percent, approximately 15 percent, approximately 20 percent, approximately 25 percent or approximately 30 percent, in each case wherein the percentage drops are based on the meal consumed for the immediately preceding set period of time or are based on the first meal and the set comes with instructions to a user to follow a method according to claim 14.

23. A set of rings of different sizes for use in a method for facilitating weight loss according to claim 17, the set comprising a ring of a first predetermined size, a ring of a second predetermined size that is a set percentage smaller than the first ring, a ring of a third predetermined size that is the same set percentage less than the second ring, and optionally rings of further predetermined sizes wherein each subsequent ring is the same set percentage smaller than the ring preceding it.

24. The use of eating dishes in the manufacture of a weight loss product comprising a set of the dishes wherein the product is for facilitating weight loss by a method comprising the steps:
a) consuming meals for a first set period of time wherein such meals occupy a first predetermined volume on or in a container,
b) after the first set period of time has run its course, consuming meals for a second set period of time wherein such meals occupy a second predetermined volume on or in a container wherein the second predetermined volume is a set percentage less than the first predetermined volume,
c) after the second set period of time has run its course, consuming meals for a third set period of time wherein such meals occupy a third predetermined volume on or in a container wherein the third predetermined volume is a set percentage less than the second predetermined volume, and
d) optionally progressively reducing meal sizes over subsequent predetermined set periods of time in the same manner as above until a final meal size is reached.

25. A use according to claim 24, wherein the set percentage is substantially the same in each case.

26. The use of rings of different sizes in the manufacture of a weight loss product comprising a set of the rings wherein the product is for facilitating weight loss by a method comprising the steps:
a) consuming meals for a first set period of time wherein such meals occupy a first predetermined volume within a first one of the rings on or in a container,
b) after the first set period of time has run its course, consuming meals for a second set period of time wherein such meals occupy a second predetermined volume within a second one of the rings on or in a container wherein the second predetermined volume is a set percentage less than the first predetermined volume and the second ring is a set percentage smaller than the first ring,
c) after the second set period of time has run its course, consuming meals for a third set period of time wherein such meals occupy a third predetermined volume within a third one of the rings on or in a container wherein the third predetermined volume is a set percentage less than the second predetermined volume and the third ring is a set percentage smaller than the second ring, and
d) optionally progressively reducing meal sizes over subsequent predetermined set periods of time in the same manner as above until a final meal size is reached.

27. A use according to claim 26, wherein the set percentage is substantially the same in each case.
